(19) United States
(12) Patent Application Publication
(10) Pub. No.: US 2008/0304774 A1
(43) Pub. Date: Dec. 11, 2008

(54) Method and apparatus for pneumatic preloading of linear bearing assemblies

(75) Inventors: Steven J. Gilbert, Rochester, NY (US); Edward T. Polidor, Webster, NY (US); Edward J. Merrltt, JR., Caledonia, NY (US)

Correspondence Address: Steven R. Scott;Shlesinger & Fitzsimmons, Suite 1323, 183 East Main Street, Rochester, NY, 14604, US

(73) Assignee: Quality Vision International, Inc.

(21) Appl. No.: 11/811,549

(22) Filed: Jun. 11, 2007

(51) Int. Cl. F16C 29/12

(52) U.S. Cl. 384/57

(57) ABSTRACT

This method and apparatus for pneumatic preloading of linear bearing assemblies is based on typical slide assemblies having ball bearing sets in rolling engagement with opposed and confronting bearing races slidably joining a base and a slide member. For adjustably preloading the bearing races, at least one and preferably a plurality of flexible, laterally expanding pneumatic tubes are positioned between a solid portion of the base and an adjustable member supporting a bearing race. Air pressure is then applied to the flexible tube(s), causing it/them to expand laterally and force confronting bearing races together to preload the bearing races. The adjustable member is then tightly secured to the base and the air pressure is removed. The tube(s) are left in position in a deflated state, and can be reused to perform the same procedure should it become necessary at a later time during the life of the assembly.

### BACKGROUND AND SUMMARY

This invention relates generally to linear ball/roller bearing slide assemblies for use with precision instruments and the like, including optical instruments, and more particularly to an improved pneumatic method and apparatus for preloading the bearing assembly or assemblies of such a slide so as to increase rigidity and achieve a play-free guideway.

Linear bearing slide assemblies of the type described normally comprise a generally rectangularly shaped base or outer section having in its upper surface an elongate, generally rectangular groove which opens on opposite ends of the outer member so that an upper portion of the base has a U-shaped cross-section with opposed uprights. An inner slide member is mounted for sliding movement in the groove in the outer member between the two uprights via two sets of bearings, which are interposed between the opposed, longitudinal side edges of the inner slide member, and the confronting side edges of the uprights of the outer base member. Thus, the slide member is supported at opposite sides thereof by the two sets of bearings for longitudinal sliding movement between the uprights of, and in the groove formed in, the outer base member. By way of example, typical linear ball bearing slides are disclosed in U.S. Pat. Nos. 4,334,717, 3,113,807, 5,106,207, 5,374,128, and 5,492,414, all of which patents are assigned to the same Assignee as the instant application.

However, it is generally necessary to apply a mechanical preload to the bearings of such slide assemblies in order to obtain smooth, shake-free operation of the slide. There are currently a variety of ways for achieving this goal by preloading the bearing races of such slides. U.S. Pat. Nos. 3,113,807 and 4,334,717, for example, disclose the use of elongated, tapered gibs, which are adjustable of the associated slide to effect the necessary preloading of the ball bearing races which are utilized for supporting the slides for longitudinal movement. U.S. Pat. Nos. 2,672,378 and 3,052,503, on the other hand, teach the use of adjustable bolts for selectively urging one raceway laterally toward the other to effect the desired preloading. (See, also, U.S. Pat. No. 5,374,128). And, while these prior art devices can be used to effect the necessary preloading of a linear bearing slide, they require a trial-and-error approach to the task of achieving an optimal torque and/or precise supporting features to achieve uniform elastic deformation.

Thus, it is a primary object of this invention to provide an improved bearing slide preload method and apparatus that does not require trial-and-error or precision methods. Further objects of the invention are to provide a bearing slide of the type described which: utilizes a more compact and inexpensive means for effecting the desired preloading of such slides; eliminates the need for utilizing tapered gibs and multiple adjustable screws for effecting the preloading of the associated ball races of the slide; and is simple and inexpensive to manufacture, as compared to preloading means heretofore employed in slides of the type described. These results are obtained by a unique pneumatic approach that provides a uniform and controlled preload in order to improve the rigidity and accuracy of the linear bearing slide mechanism.

The pneumatic preload method and apparatus of our invention features, in its preferred embodiments, the usual outer base member having a pair of spaced, parallel upright sections supporting opposite sides of an inner slide member via ball bearing sets. The ball bearing sets have rolling engagement with opposed and confronting bearing races comprising a V-rail on one side and laterally spaced pairs of elongate bearing rods on the other, with the V-rails being seated in longitudinal L-shaped grooves in the uprights of the base member and the bearing rods being seated in opposing rectangular shaped longitudinal grooves formed in side edges of the inner slide member.

For adjustably preloading the bearing races formed by the bearing rods and V-rails on each side of the slide member, flexible, laterally expanding pneumatic tubes are positioned between a solid portion of an upright and an adjustable member (which can be one of the V-rails or channels for the rods that support the bearings in the bearing sets on both sides). During assembly, air pressure is applied to the flexible tubes and causes them to expand, thus providing an exactly controllable preload to the bearing races. The motion of the slide member is measured for accuracy and the pressure is varied until the specified performance is achieved. The adjustable member is then tightly secured to the base and the air pressure is removed. The tubes are left in position in a deflated state, and can be reused to perform the same precise assembly procedure, should a repair, readjustment, or refinement become necessary at a later time during the life of the assembly.

### BRIEF DESCRIPTION OF THE DRAWINGS

FIG. 1 provides a perspective view from above of a typical outer base of the invention sans an inner slide member fitted thereto.

FIG. 2 provides a view from above of the outer base illustrated in FIG. 1.

FIG. 3 provides a cross-sectional view taken through 3-3 of FIG. 2, including the inner slide member omitted in FIGS. 1 and 2, of the slide assembly of the invention.

### DESCRIPTION

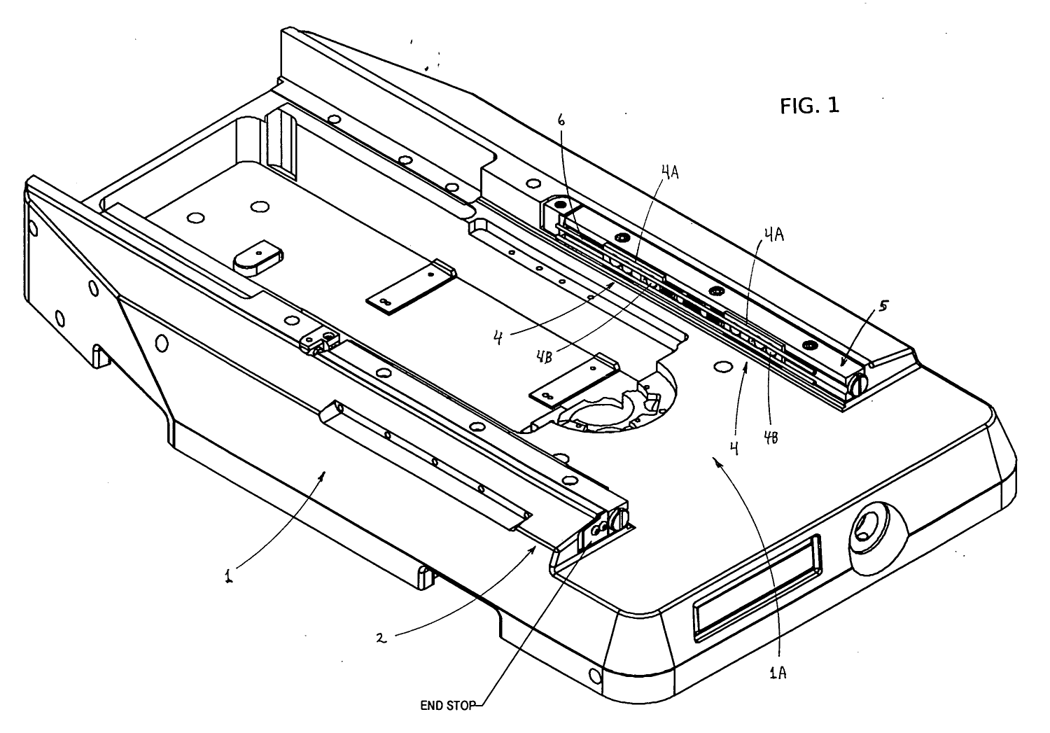

As previously discussed, our invention relates generally to linear bearing slide assemblies for use with precision instruments and the like, such as the typical assembly illustrated in FIGS. 1 through 3. As will be noted upon review of these drawing figures, a typical assembly of this type features a generally rectangularly shaped outer section or base 1 having in its upper surface an elongate, generally rectangular groove 1A which opens on opposite ends of the base 1 so that an upper portion of the base 1 has a U-shaped cross-section with opposed uprights 2. An inner slide member 3 is mounted for sliding movement in the groove 1A in the base 1 between the two uprights 2 via ball bearing sets 4, which are interposed between the opposed, longitudinal side edges of the inner slide member 3, and the confronting inside edges of the uprights 2 of base 1. Thus, the slide member 3 is supported at opposite sides thereof by ball bearing sets 4 for longitudinal sliding movement between the uprights 2 of, and in the groove 1A formed in, the outer member, base 1.

Each ball bearing set 4 has rolling engagement with the opposed and confronting bearing races formed by a longitudinal V-rail 5 on one side and laterally spaced pairs of elongate cylindrical bearing rods 6 on the other. The V-rails 5 are seated in longitudinal L-shaped grooves 2B in the uprights 2 of the base 1 and the bearing rods 6 are seated in corners of opposing rectangular shaped longitudinal grooves 3A formed in side edges of the inner slide member 3. The bearing rods 6 and V-rails 5 on each side form together paired and confronting ball bearing races which extend longitudinally of base member 1 and slide member 3 on each side of slide member 3.

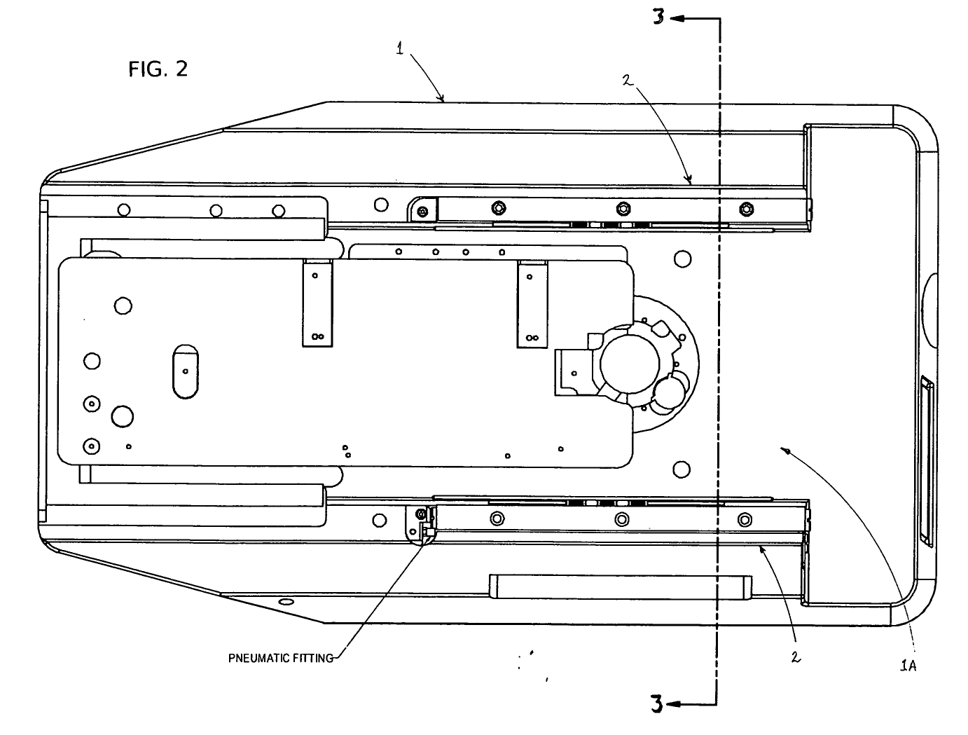

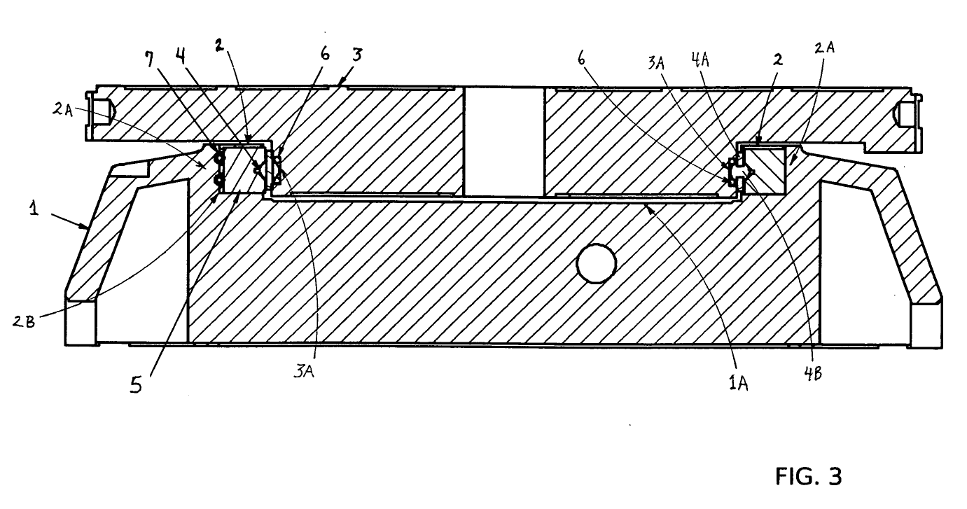

As shown more clearly in FIGS. 2 and 3, the space between the inside confronting surfaces of uprights 2 is slightly greater than the width of the slide member 3. This leaves two narrow spaces between the uprights 2 and slide member 3, allowing for conventional ball bearing sets 4 comprising elongate ball bearing keeper plates or retainers 4A, each of which has mounted therein in a conventional manner a plurality (four in the embodiment illustrated) of longitudinally spaced ball bearings 4B, respectively. The ball bearings 4B have rolling engagement with the bearing rods 6 on one side and the V-rails 5 on the other, thus supporting the slide member 3 in a conventional manner on the base 1 for longitudinal movement relative thereto.

For adjustably preloading the bearing assemblies formed by the bearing races (which are comprised of the rods 6, V-rails 5, and bearing sets 4 on each side of the slide member 3), at least one and preferably a plurality of flexible, laterally expanding pneumatic tube(s) 7 is/are positioned between a solid portion 2A of an upright 2 and an adjustable member (which in this embodiment is one of the V-rails 5) that supports the bearing sets 4. Preferably, so that pressure is evenly exerted over the whole length of the bearing assembly, tube(s) 7 are parallel to the bearing races formed by rods 6 and V-rails 5.

During assembly, air pressure is applied to the flexible tube(s) 7, causing it/them to expand, and thereby providing and applying pressure not only on the bearing assembly proximate the flexible tube(s) 7, but on the distal bearing assembly on the opposite side of slide member 3. (This is accomplished via slide member 3, which acts as a rigid carrier and conveyor of the force produced by tube(s) 7 to the said distal bearing assembly). Thus, the provision of pneumatic tube(s) 7 on one side of slide member 3 can be used to preload the bearing assemblies/races on both sides of slide member 3.

The pressure exerted and produced by and in tube(s) 7 is exactly controllable and can be monitored by a pressure gage, forming an exact and controlled preload to the said bearing assemblies/races. The motion of the slide member 3 can then be measured for accuracy and the pressure exerted by tube(s) 7 varied until the desired performance is achieved. The adjustable member (V-rails 5) is then tightly secured to the base 1 and the air pressure removed. However, tube(s) 7 are left in position in a deflated state, and can be reused to perform the same precise bearing assembly loading procedure, should a repair, readjustment, or refinement become necessary at a later time during the life of the assembly. Thus, by adjusting the pressure in pneumatic tube(s) 7, the preloading of the bearings 4B can be effected very simply upon initial assembly of the slide to compensate for any manufacturing tolerances, and also to permit adjustment thereafter to compensate for wear caused by prolonged use of the slide.

However, while our invention has been illustrated and described in connection with only certain embodiments thereof, it will be apparent that it is capable of still further modification, and that this application is intended to cover any such modifications as may fall within the scope of one skilled in the art, or the appended claims. For example, although ball bearings 4B are employed to support both sides of slide 3 in the embodiment described, it will be apparent to one skilled in the art that roller bearings could be employed on either side without departing from this invention. Also, of course, the positioning and use of either or both bearing rods 6 and V-rails 5 in constructing the bearing races of the invention could be varied by using only one or the other, changing which type of bearing support is used on which side of the slide 3, changing which one is adjusted via pneumatic tube(s) 7, and by other such changes (though we deem the current arrangement to be preferred). Further, various of the above-disclosed and other features and functions, or alternatives thereof, may be desirably combined into many other different systems or applications. Thus, various presently unforeseen or unanticipated alternatives, modifications, variations or improvements therein may be subsequently made by those skilled in the art which are also intended to be encompassed by the following claims.

What is claimed is:

1. An apparatus for preloading linear bearing assemblies, comprising:
a linear bearing slide assembly including a base and a slide member slidably connected via a linear bearing assembly; and
a pneumatic system for preloading the bearing assembly, which pneumatic system urges an adjustable member of the bearing assembly towards an other portion of the bearing assembly to preload the bearing assembly.

2. The apparatus of claim 1, wherein said adjustable member can be fixed in position after preloading to maintain the load imposed on the bearing assembly.

3. The apparatus of claim 1, wherein the adjustable member is a V-rail of the bearing assembly.

4. The apparatus of claim 1, wherein the pneumatic system can be re-used after preloading to adjust the load on the bearing assembly.

5. The apparatus of claim 1, wherein the pneumatic system includes at least one pressurizable tube, which tube expands laterally when pressurized to urge the adjustable member of the bearing assembly towards the other said portion of the bearing assembly to preload the bearing assembly.

6. The apparatus of claim 5, wherein the at least one tube is substantially parallel to the linear bearing assembly.

7. The apparatus of claim 5, wherein the at least one tube is positioned between a fixed member of the bearing slide assembly and the adjustable member.

8. An apparatus for preloading linear bearing assemblies, comprising:
a linear bearing slide assembly including a base and a slide member slidably connected via a plurality of linear bearing assemblies; and
a pneumatic system for preloading the plurality of bearing assemblies, which pneumatic system urges an adjustable member of at least one bearing assembly of the plurality of bearing assemblies towards an other portion of the at least one bearing assembly to preload the plurality of bearing assemblies.

9. The apparatus of claim 8, wherein said adjustable member can be fixed in position after preloading to maintain the load imposed on the bearing assemblies.

10. The apparatus of claim 8, wherein the adjustable member is a V-rail of the at least one bearing assembly.

11. The apparatus of claim 8, wherein the pneumatic system can be re-used after preloading to adjust the load on the plurality of bearing assemblies.

12. The apparatus of claim 8, wherein the pneumatic system includes at least one pressurizable tube, which tube expands laterally when pressurized to urge the adjustable member of the at least one bearing assembly towards the other said portion of the bearing assembly to preload the at least one bearing assembly.

13. The apparatus of claim 12, wherein the at least one tube is substantially parallel to the at least one linear bearing assembly.

14. The apparatus of claim 12, wherein the at least one tube is positioned between a fixed member of the bearing slide assembly and the adjustable member.

15. A method for preloading linear bearing assemblies, comprising:
providing a linear bearing slide assembly including a base and a slide member slidably connected via a linear bearing assembly, and a pneumatic system for preloading the bearing assembly, which pneumatic system urges an adjustable member of the bearing assembly towards an other portion of the bearing assembly to preload the bearing assembly;
pressurizing the pneumatic system to preload the bearing assembly; and
fixing the adjustable member in position so as to maintain the load imposed on the bearing assembly.

16. The method of claim 15, further comprising loosening the adjustable member so that its position can be readjusted, pressurizing the pneumatic tube to readjust the position of the adjustable member and reload the bearing assembly, and fixing the adjustable member in position so as to maintain the reload imposed on the bearing assembly.

17. The method of claim 15, wherein the pneumatic system includes at least one pressurizable tube, which tube expands laterally when pressurized to urge the adjustable member of the bearing assembly towards the other said portion of the bearing assembly to preload the bearing assembly.

18. The method of claim 16, wherein the pneumatic system includes at least one pressurizable tube, which tube expands laterally when pressurized to urge the adjustable member of the bearing assembly towards the other said portion of the bearing assembly to preload and reload the bearing assembly.
